(19) United States
(12) Patent Application Publication
(10) Pub. No.: US 2021/0230036 A1
(43) Pub. Date: Jul. 29, 2021

(54) PROCESS FOR REMOVING SILICA FROM HIGH PH BRINES PRODUCED BY EVAPORATION IN THE COURSE OF TREATING PRODUCED WATER

(71) Applicant: Veolia Water Technologies, Inc., Cary, NC (US)

(72) Inventor: Mark C. Nicholson, Pewaukee, WI (US)

(73) Assignee: Veolia Water Technologies, Inc., Cary, NC (US)

(21) Appl. No.: 17/253,220

(22) PCT Filed: Dec. 4, 2020
(86) PCT No.: PCT/US2020/063352

§ 371 Date: Dec. 17, 2020

Related U.S. Application Data
(60) Provisional application No. 62/944,451, filed on Dec. 6, 2019.

(51) Int. Cl. C02F 9/00

(52) U.S. Cl. CPC C02F 9/00; C02F 2103/365

(57) ABSTRACT

The present invention relates to a process for removing dissolved silica from a high pH brine produced by an evaporator employed in treating a waste stream. The high pH brine is directed to a crystallizer reactor and an acid or CO₂ is mixed therewith to reduce the pH of the brine, causing the silica in the brine to precipitate. The brine is then directed to a first solids-liquid separator which produces a slurry containing the precipitated silica. The slurry is split into first and second streams with one stream recycled to the crystallizer reactor while the other slurry stream is directed to a second solids-liquid separator which produces a wet cake containing the silica solids.

### FIELD OF THE INVENTION

The present invention relates to produced water treatment, and more particularly to a process for removing silica from brines produced by evaporators in the course of treating produced water.

### BACKGROUND

Produced water typically includes high concentrations of silica, as well as suspended solids and other contaminants. Conventional treatment of produced water includes a pre-treatment process followed by an evaporation process that produces a brine in the form of a concentrate or blowdown. In some cases, this brine has a relatively high pH on the order of 9.5 and above as a result of adjusting the pH upwardly in the pre-treatment process or in the evaporator itself. This increases the solubility of silica and prevents the silica from scaling the evaporator components, as well as other downstream equipment.

The concentrated brine is often disposed of via deep well. However, brine with high levels of silica require the silica to be removed prior to disposal of the brine. If the silica is not removed, the dissolved silica can precipitate in the disposal well when contacted with well water.

There are processes that remove silica from evaporator brine. But these processes have a number of drawbacks. Some of these processes include chemical reactions that are slow and result in post-precipitation of silica throughout the system treating the brine. This can plug lines and other equipment with silica scale. Moreover, the silica solids in these conventional processes will likely be quite small and difficult to remove by typical filtration and centrifuge processes.

The process of the present invention addresses these drawbacks. The process of the present invention aims to recycle silica suspended solids (TSS or ‘seeds’) to a reactor vessel where the brine containing high levels of dissolved silica is reacted with acid. These ‘seeds’ provide a large amount of surface area for precipitation of silica upon lowering the pH with acid. The benefits of recycling seeds is as follows: (1) the size of the precipitated silica increases. This greatly facilitates the filtration and removal of silica from the brine through a centrifuge, filter press, or other appropriate solids-liquid separators. (2) By providing surface area for the silica to precipitate, the silica precipitation reaction is driven to completion i.e. precipitation occurs in the reactor vessel, not downstream as post precipitation. Post precipitation can cause plugging in equipment downstream of the reactor vessel (e.g. pipe lines, filter clothes, and disposal wells). This is achieved in part by first precipitating dissolved silica from the brine in a crystallizer reactor. Thereafter, the brine containing the precipitated silica is directed to a solids-liquid separator which produces a slurry containing the silica solids or silica TSS. A portion of this slurry containing the silica is recycled back to the crystallizer reactor where the silica solids in the slurry acts as a seed that provides preferred silica precipitation sites. Hence, this process increases the size of the solid silica particle and facilitates their removal downstream of the crystallizer reactor via a centrifuge or other filtration device.

### SUMMARY OF THE INVENTION

The present invention relates to a produced water treatment process for treating produced water having a high concentration of silica. The process includes an evaporator that produces a high pH brine in the form of a concentrate or blowdown. To remove the silica from the brine, the brine is mixed with an acid or CO₂ which lowers the pH of the brine and decreases the solubility of silica therein. This results in the silica precipitating from the brine. Thereafter, the brine containing the precipitated silica is directed to a first solids-liquid separator which produces a first liquid stream and a slurry containing precipitated silica. First, the slurry is split into first and second slurry streams. One of the slurry streams is recycled back to the reactor to where the silica precipitation occurs. The silica in the slurry stream acts as a seed and a preferential site for the silica to precipitate and this results in increasing the size of the solid silica particles and ensures that all of the silica is reacted and precipitated. This facilitates the removal of the silica particles through a centrifuge process or other appropriate filtration processes and prevents precipitation of silica in downstream equipment

In one particular embodiment of the present invention, the process of the present invention entails a process for recovering oil and treating evaporator concentrate produced during the process comprising:

recovering an oil-water mixture from an oil well;

separating oil from the oil-water mixture to produce an oil product and produced water having a dissolved silica concentration of at least 300 mg/L;

directing the produced water to an evaporator and producing a distillate and a concentrated brine having a pH of at least 9.5;

removing silica from the concentrated brine by precipitating silica and increasing the size of the precipitated silica to facilitate the removal of silica in a solids-liquid separation process, the method of removing silica from the concentrated brine including:
i. directing the concentrated brine to a crystallizer reactor;
ii. reducing the pH of the concentrated brine in the crystallizer reactor to approximately 6-8 by mixing an acid or CO₂ with the concentrated brine in the crystallizer reactor;
iii. precipitating silica from the concentrated brine in the crystallizer reactor;
iv. after precipitating the silica from the concentrated brine, directing the brine having the precipitated silica therein to a first solids-liquid separator and producing a first liquid stream and a slurry containing the precipitated silica;
v. disposing of or further treating the first liquid stream;
vi. splitting the slurry into a first slurry stream and a second slurry stream;
vii. directing the first slurry stream to a second solids-liquid separator and producing a second liquid stream and a solids wet cake for disposal. The wet cake is essentially silica solids, but could contain other precipitated material like organics and hardness;
viii. facilitating the precipitation of silica in the crystallizer reactor by recycling the second slurry stream to the crystallizer reactor where the silica in the second slurry stream acts as a seed for newly precipitated silica, which in turn increases the size of the precipitated silica and forces the silica reaction to completion in the crystallizer reactor.
   In another embodiment, the present invention entails a process for removing silica from a high pH concentrate or blowdown produced by a thermal evaporator employed in treating a waste stream. This process comprises:

directing the waste stream having a silica concentration of 300 mg/L or greater to the evaporator and evaporating the waste stream to produce the concentrate or blowdown having a pH of 9.5 or higher;

directing the concentrate or blowdown to a crystallizer reactor;

reducing the pH of the concentrate or blowdown in the crystallizer reactor to approximately 6-8 by mixing an acid or CO₂ with the concentrate or blowdown in the crystallizer reactor;

wherein by reducing the pH of the concentrate or blowdown reduces the solubility of silica and causes dissolved silica to precipitate in the crystallizer reactor;

after precipitating the silica in the crystallizer reactor, directing the concentrate or blowdown to a first solids-liquid separator and producing a liquid stream and a slurry containing the precipitated silica;

splitting the slurry into first and second slurry streams;

directing the first slurry stream to a solids-liquid separator and producing a second liquid stream and a wet cake containing silica solids; and

facilitating the removal of silica from the concentrate or blowdown by increasing the size of the precipitated silica in the crystallizer reactor by recycling the second slurry stream containing precipitated silica to the crystallizer reactor where the silica in the second slurry stream functions as a seed which increases the size of the precipitated silica in the crystallizer reactor.

Other objects and advantages of the present invention will become apparent and obvious from a study of the following description and the accompanying drawings which are merely illustrative of such invention.

### BRIEF DESCRIPTION OF THE DRAWINGS

FIG. 1 illustrates a produced water treatment process where silica is removed from a high pH brine produced by an evaporator used in treating the produced water.

FIG. 2 is a schematic illustration of a process that treats high pH brine from an evaporator where the brine includes dissolved silica. FIG. 3 is a schematic illustration of a produced water treatment process where the evaporator brine includes dissolved silica and the process entails removing the dissolved silica from the concentrated brine prior to the brine being disposed of through deep well injection or other suitable approaches.

### DESCRIPTION OF PREFERRED EMBODIMENT

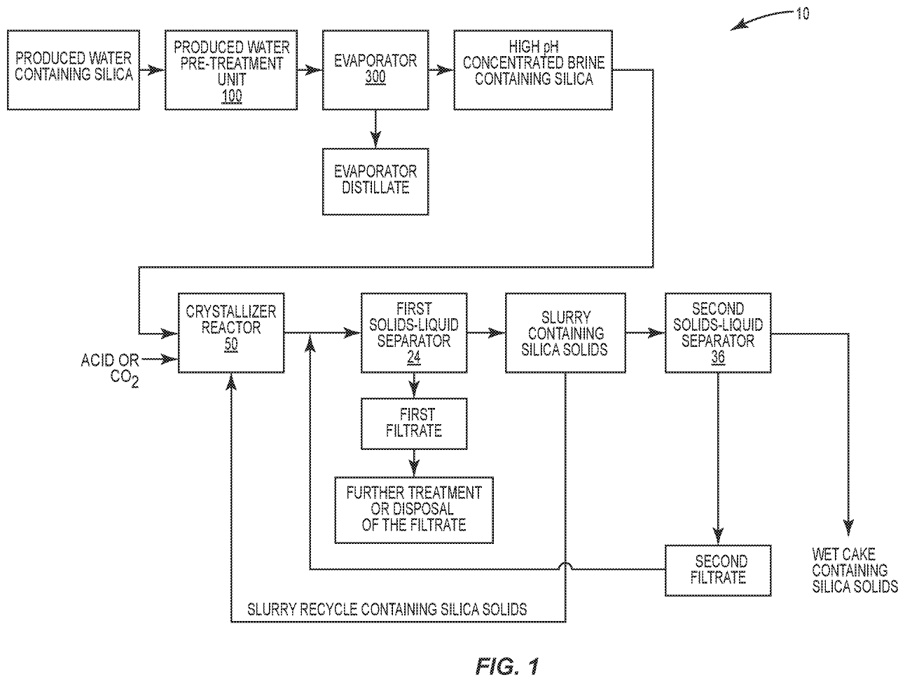

With further reference to the drawings, particularly FIG. 1, there is shown a produced water treatment process that produces a high pH brine containing silica. As shown in FIG. 1, the produced water containing silica (typically of a concentration of approximately 300 mg/L) is directed to a produced water pre-treatment unit 100. Various types and forms of pre-treatment can occur here. In many cases, it is desirable in the pre-treatment process to raise the pH of the produced water. This can be achieved by adding sodium hydroxide or other chemicals that raise the pH of the produced water. The reason for this is to increase the solubility of silica in the produced water so that the silica stays in solution and does not precipitate and scale the evaporator or other downstream equipment. In any event, after pre-treatment the produced water is directed to a thermal evaporator 300. Evaporator 300 produces a distillate and a high pH brine that contains a significant silica concentration which can be as high as 15,000 mg/L. After producing the high pH brine, the process focuses on removing the silica from the brine. The high pH brine, having a pH of 9.5 and higher, is directed to a crystallizer reactor 50. Here an acid, such as HCl and H₂CO₄, is mixed with the brine in the crystallizer reactor 50. CO₂ can also be used to lower the pH. Sufficient acid or CO₂ is mixed with brine in the crystallizer reactor 50 so as to lower the pH of the brine to a neutral pH, preferably 6-8. This reduces the solubility of silica and silica precipitates from the brine in the crystallizer reactor 50.

The brine containing the precipitated silica and at a lower pH is directed to a first solids-liquid separator 24, such as a centrifuge or other appropriate solids separation device. This produces a first liquid stream that in FIG. 1 is referred to as a first filtrate. The first filtrate can be subjected to additional treatment or can be appropriately disposed of.

Further, the first solids-liquid separator 24 produces a slurry containing the silica and other contaminants, such as suspended solids and other precipitants. The slurry produced by the first solids separator 24 is split into first and second streams. The first slurry stream is directed to a second solids-liquid separator 36. It produces a second filtrate that can be recycled and mixed with the brine containing the precipitated silica. The second solids-liquid separator 36 produces two streams: (1) a filtrate or centrate (non-suspended solids brine) and (2) a wet cake containing silica solids.

The second slurry stream, referred to in FIG. 1 as “Slurry Recycle Containing Silica Solids” is recycled back to the crystallizer reactor 50. In one embodiment, the silica solids in the second slurry stream constitute approximately 20%-30% by weight of the slurry. This slurry stream is mixed with the brine in the crystallizer reactor 50 and the silica solids therein provides a seed to facilitate the further precipitation of silica in the crystallizer reactor 50. The silica seed density in the crystallizer reactor 50 should be at least 1%. That is the precipitated silica in the crystallizer reactor 50 that acts as a seed should constitute at least 1% by weight of the brine in the crystallizer reactor. Silica solids contained in the recycled slurry stream acts as a seed and a preferential site for further precipitation which results in the silica particles growing in size, which in turn facilitates their removal through various filtering processes downstream.

The concept underlying the process shown in FIG. 1 is that the first solids-liquid separator provides the seed recycle and makes a generally clear brine stream that is appropriate for disposal. The second solids-liquid separator takes out the silica solids from the slurry as a wet cake (i.e., mostly solids with little or no liquid). The second solids-liquid separator does not need to make as good of a clear brine as this clear brine can be either disposed of if its quality is sufficient or recycled back to the crystallizer reactor.

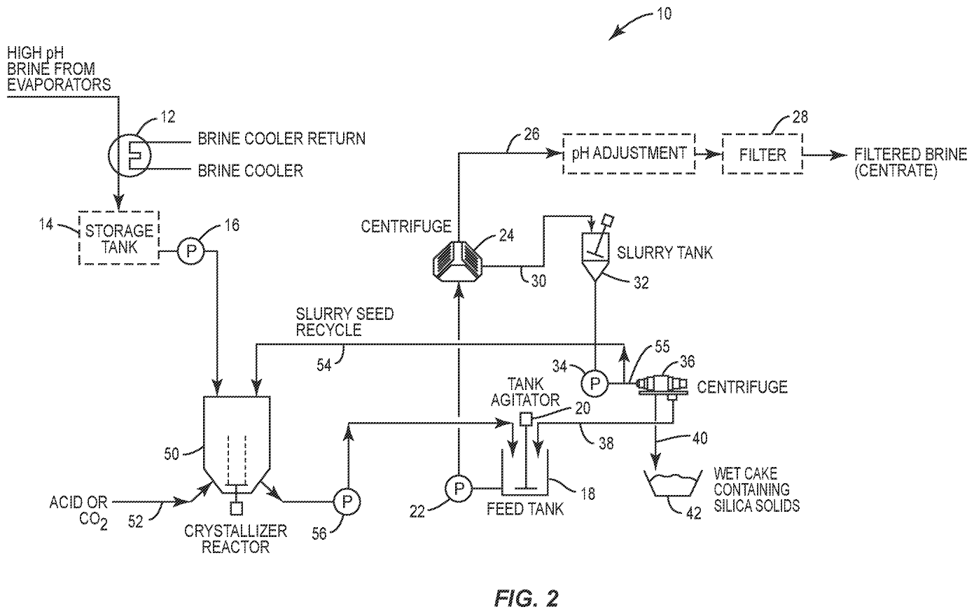

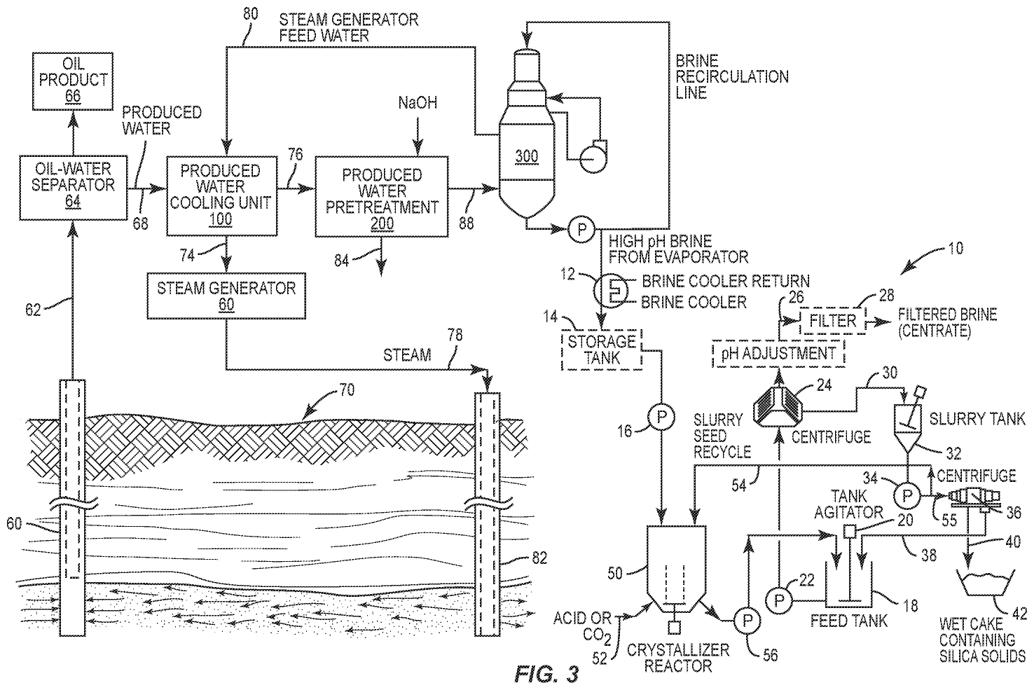

FIG. 2 illustrates a process for producing a high pH brine by an evaporator 300. The process is similar in concept to that discussed above and shown in FIG. 1 but includes a more detailed description of the components for treating the brine. With reference to FIG. 2, evaporator brine is cooled by directing the brine through a heat exchanger 12. Heat exchanger 12 is optional. Downstream of the heat exchanger 12 is an optional storage tank 14 that collects and holds the evaporator brine. A pump 16 is provided and pumps the evaporator brine from the storage tank 14 to a crystallizer reactor 50. As noted above, the pH of the brine is typically 9.5 or higher. In order to precipitate the silica contained in the brine, it is necessary to reduce the pH of the brine and hence lower the solubility limits of the silica to induce silica precipitation. To accomplish this, an acid such as HCl or H₂SO₄ is directed through line 52 into the crystallizer reactor 50 and mixed with the evaporator brine. As an alternative, the pH of the brine can be reduced by mixing CO₂ with the brine in the crystallizer reactor 50.

The brine containing the precipitated silica is pumped by pump 56 to a feed tank 18. As will be discussed later, a liquid stream from a downstream centrifuge 36 is also mixed with the brine in the feed tank 18 and mixed and agitated by a tank agitator 20.

Brine contained in the feed tank 18 is pumped by pump 22 to a highly efficient centrifuge for the purpose of separating the silica solids from the evaporated brine. It is advantageous to employ a centrifuge device that is effective to separate the very small silica particles from the evaporator brine. Various types of centrifuges and other solids-liquid separation devices can be used. In one embodiment, the centrifuge employed is a disk stack centrifuge that is indicated by the numeral 24 in FIG. 2. The disk stack centrifuge is designed to remove small particles and in this case particularly small silica particles which in many cases will yield a solids-free centrate for disposal and also a slurry discharge. Since the disk stack centrifuge produces a concentrated slurry, the slurry can easily be recycled and forwarded to the second solids-liquid separation device which produces the wet cake containing silica solids and which is suitable for disposal. Details of the disk stack centrifuge 24 are not dealt with herein because the structure of such is not per se material to the present invention. It should be pointed out that other solids-liquid separation devices can be used here in lieu of the disk stack centrifuge.

Centrifuge 24 produces a first liquid stream 26 that can be further treated or in some cases disposed of. For example, and as an option, the liquid stream in line 26 can be subjected to pH adjustment, as well as filtration (filter 28). This results in the production of a filtered brine (centrate).

Since the centrifuge 24 is a separation device, it produces a slurry stream 30. The slurry stream will include the precipitated silica and other contaminants such as suspended solids and other precipitants. Slurry stream 30 is directed to a slurry tank 32 and the slurry is subjected to mixing therein. A pump 34 pumps the slurry from the slurry tank 32 to a second solids-liquid separation device 36 which, in the case of one embodiment, is a centrifuge. However, prior to the slurry reaching the centrifuge 36, it is split into a first slurry stream 54 and a second slurry stream 55. The second slurry stream 55 is directed into the second solids-liquid separation device 36. Separation device 36 produces a wet cake containing silica solids via line 40. The second solids-liquid separation device 36 also produces a second liquid stream 38 which was alluded to above. This second liquid stream 38, in one embodiment, is directed to the feed tank 18 and mixed with the evaporator brine containing the precipitated silica.

As discussed above, one of the drawbacks in conventional silica removal processes involving high pH evaporator brine is that the silica removed is so tiny it is difficult to remove with conventional filtration systems. Thus, one of the goals of the present invention is to increase the size of the silica solids or particles in the brine so as to facilitate removal. In the case of the FIG. 2 embodiment, this is achieved by directing the first slurry stream 54 back to the crystallizer reactor 50 where the silica in the slurry acts as precipitation sites for newly precipitated silica. This enhances the size of the solid silica particles in the crystallizer reactor 50. In other words, this allows newly precipitated silica a “seed” to precipitate on, thus increasing the size of the silica particles. As noted above, a larger seed is easier to filter and remove from the system. In addition, the recycled silica solid provides a preferred site for the silica to precipitate on. Also, by recycling the silica solids this gives rise to a complete or nearly complete silica reaction in the crystallizer reactor 50 and generally prevents post-precipitation from occurring in downstream lines and equipment.

FIG. 3 depicts a particular Steam Assisted Gravity Drainage (SAGD) process that is similar in many respects to the basic process shown in FIG. 2 and described above. For that reason, parts of the FIG. 3 process will not be described in detail as such was described above with respect to the FIG. 2 embodiment. The FIG. 3 process is generally referred to as a high pH produced water process. This process is employed when the produced water has a relatively high (in some cases the dissolved silica concentration is approximately 300 mg/L) concentration of soluble silica. Elevating the pH of the produced water, as discussed above, increases the solubility of the dissolved silica and reduces silica scaling in process equipment, particularly the evaporator 300. As shown in FIG. 3, sodium hydroxide is added to the produced water. This raises the pH of the produced water to 9.5 or higher. As noted above, this increases the solubility of silica in the produced water and can tend to reduce silica scaling in the downstream evaporator 300. In some high pH produced water processes, all or substantially all of the dissolved silica remains soluble and ends up in the evaporator brine. In the case of the FIG. 3 embodiment, the evaporator brine treatment includes the crystallizer reactor 50 which is fed an acid or CO₂ which results in the pH of the brine being lowered, which in turn causes the soluble silica to precipitate. Like the process described in FIG. 2, the slurry containing the silica solids from the first solids-liquid separation device 24 is split into two streams with one of the slurry streams recycling silica solids as a seed to the crystallizer reactor 50 for the purposes discussed above.

Although the present methods and processes have been shown and described in considerable detail with respect to only a few/particular exemplary embodiments thereof, it should be understood by those skilled in the art that it is not intended to limit the methods or processes to the embodiments, as various modifications, omissions, and additions may be made to the disclosed embodiments without materially departing from the novel teachings and advantages described herein.

What is claimed is:

1. A process of recovering oil and treating evaporator concentrate produced during the process, the process comprising:
recovering an oil-water mixture from an oil well;
separating oil from the oil-water mixture to produce an oil product and produced water having a dissolved silica concentration of at least 300 mg/L;
directing the produced water to an evaporator and producing a distillate and a concentrated brine having a pH of at least 9.5;
removing silica from the concentrated brine by precipitating silica and increasing the size of the precipitated silica to facilitate the removal of silica in a solids-liquid separation process, the method of removing silica from the concentrated brine including:
i. directing the concentrated brine to a crystallizer reactor;
ii. reducing the pH of the concentrated brine in the crystallizer reactor to approximately 6-8 by mixing an acid or CO₂ with the concentrated brine in the crystallizer reactor;
iii. precipitating silica from the concentrated brine in the crystallizer reactor;
iv. after precipitating the silica from the concentrated brine, directing the brine having the precipitated silica therein to a first solids-liquid separator and producing a first liquid stream and a slurry containing the precipitated silica;
v. disposing of or further treating the first liquid stream;
vi. splitting the slurry into a first slurry stream and a second slurry stream;
vii. directing the first slurry stream to a second solids-liquid separator and producing a second liquid stream and a wet cake containing silica solids;
viii. facilitating the precipitation of silica in the crystallizer reactor by recycling the second slurry stream to the crystallizer reactor where the silica solids in the second slurry stream acts as a seed for newly precipitated silica, which in turn increases the size of the precipitated silica and facilitates a complete or nearly complete reaction of silica in the crystallizer reactor.

2. The process of claim 1 further including mixing of the second liquid stream produced by the second solids-liquid separator with the concentrated brine upstream of the first solids-liquid separator.

3. The process of claim 1 wherein there is a feed tank disposed between the crystallizer reactor and the first solids-liquid separator and wherein the process includes directing the concentrated brine from the crystallizer reactor to the feed tank and also directing the second liquid stream from the second solids-liquid separator to the feed tank and mixing the concentrated brine and the second liquid stream in the feed tank.

4. The process of claim 1 further including directing the slurry from the first solids-liquid separator to a slurry tank and mixing the slurry therein prior to the slurry being directed to the second solids-liquid separator.

5. A process for removing silica from a high pH concentrate or blowdown produced by a thermal evaporator employed in treating a waste stream, the process comprising:
directing the waste stream having dissolved silica to the evaporator and evaporating the waste stream to produce the concentrate or blowdown having a pH of 9.5 or higher;
directing the concentrate or blowdown to a crystallizer reactor;
reducing the pH of the concentrate or blowdown in the crystallizer reactor to approximately 6-8 by mixing an acid or CO₂ with the concentrate or blowdown in the crystallizer reactor;
wherein reducing the pH of the concentrate or blowdown reduces the solubility of silica and causes dissolved silica to precipitate in the crystallizer reactor;
after precipitating the silica in the crystallizer reactor, directing the concentrate or blowdown to a first solids-liquid separator and producing a liquid stream and a slurry containing the precipitated silica;
splitting the slurry into first and second slurry streams;
directing the first slurry stream to a second solids-liquid separator and producing a second liquid stream and wet cake containing silica solids; and
facilitating the removal of dissolved silica from the concentrate or blowdown by increasing the size of the precipitated silica in the crystallizer reactor by recycling the second slurry stream containing precipitated silica to the crystallizer reactor where the silica in the second slurry stream functions as a seed which increases the size of the precipitated silica in the crystallizer reactor and facilitates a complete or near complete reaction of silica in the crystallizer reactor.

6. The process of claim 5 further including mixing the second liquid stream with the concentrate or blowdown prior to the concentrate or blowdown reaching the first solids-liquid separator.

7. The process of claim 5 wherein the first solids-liquid separator comprises a disk stack centrifuge.

8. The process of claim 5 further including directing the slurry produced by the first solids-liquid separator to a mixing tank and mixing the slurry therein prior to splitting the slurry into the first and second slurry streams.

9. The process of claim 5 including directing the concentrate or blowdown containing precipitated silica to an agitated feed tank that is disposed upstream of the first solids-liquid separator; and directing the second liquid stream from the second solids-liquid separator to the agitated feed tank and mixing the second liquid stream with the concentrate or blowdown in the agitated feed tank.

10. The process of claim 5 wherein the second solids-liquid separator comprises a centrifuge or a filter press.

11. The process of claim 5 including further treating the first liquid stream by adjusting the pH of the first liquid stream and thereafter directing the first liquid stream to a filter.
